(19) United States
(12) Patent Application Publication
(10) Pub. No.: US 2006/0261744 A1
(43) Pub. Date: Nov. 23, 2006

(54) Drive apparatus and drive method for light emitting display panel

(75) Inventors: Akinori Hayafuji, Yonezawa-shi (JP); Katsuhiro Kanauchi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo (JP)

(21) Appl. No.: 11/429,961

(22) Filed: May 9, 2006

(30) Foreign Application Priority Data
May 19, 2005 (JP) 2005-146534

(51) Int. Cl. G09G 3/10

(52) U.S. Cl. 315/169.3

(57) ABSTRACT

A constant electric current value supplied to a monitoring element Ex is controlled based on dimmer information, during which time a forward voltage Vf is produced and acquired by a peak hold circuit 9. Based on output of the peak hold circuit 9, an output voltage VH of a DC-DC converter 5 is controlled, and provided as a drive voltage for a display panel.

### BACKGROUND OF THE INVENTION

1. Field of the Invention

The present invention relates to a drive apparatus and a drive method for causing and driving a display panel to emit light in which a plurality of light emitting elements are arranged, and in particular to a drive apparatus and a drive method for a light emitting display panel for carrying out brightness compensation and dimmer control corresponding to variations over time of a light emitting element.

2. Description of the Related Art

Since mobile phones, personal digital assistant terminals (PDA), etc., are widespread, there is an increasing demand for a display panel which has a high definition image display function and can realize a thin shape and low power consumption. Thus, conventionally, a liquid crystal display panel has been employed in a large number of products as a display panel which fulfils the demand. On the other hand, a display panel has been recently realized using an organic EL (electroluminescence) element which takes advantage of a characteristic of being a self-emitting type display element, thus attracting attention as a next-generation display panel which replaces the conventional liquid crystal display panel. There is also part of the background that a light-emitting functional layer of an element employs an organic compound which can expect a good light-emission property, so that the organic EL display panel has as high an efficiency and long a lifetime as can be put into practical use.

The above-mentioned organic EL element is basically arranged such that a transparent electrode of ITO (Indium Tin Oxide), a light-emitting functional layer made from an organic substance, and a metal electrode are stacked in order on a transparent substrate of glass etc. Further, the above-mentioned luminescence functional layer may be arranged to be a single layer of an organic luminescence layer, a two-layer structure constituted by an organic hole transportation layer and an organic luminescence layer, a three-layer structure constituted by an organic hole transportation layer, an organic luminescence layer, and an organic electron-transportation layer, or a multilayer structure in which an electron or electron hole injecting layer is further inserted between suitable ones of these layers.

The above-mentioned organic EL element can be electrically represented in an equivalent circuit as shown in FIG. 1. In other words, the organic EL element can be represented by a structure including a diode component E as a light emitting element and a parasitic capacitance component Cp combined in parallel with the diode component E, and it can be said that the organic EL element is a capacitive light-emitting element.

As for this organic EL element, when a light-emitting drive voltage is applied, charge which is equivalent to capacitance of the element first flows into an electrode as displacement current and is accumulated. Then, if a fixed voltage (light-emitting threshold voltage=Vth) inherent to the element is exceeded, electric current begins to flow from one electrode (anode side of the diode component E) into an organic layer which constitutes a light-emitting layer. Thus, the EL element maybe considered to emit light at an intensity proportional to the electric current.

FIG. 2 shows light-emission static characteristics of such an organic EL element. According to this, the organic EL element emits light at a brightness L substantially proportional to drive electric current I as shown in FIG. 2A. As shown by a solid line in FIG. 2B, when a drive voltage V is equal to or greater than the light-emitting threshold voltage Vth, the electric current I flows rapidly so that light is emitted.

In other words, when the drive voltage is not greater than the light-emitting threshold voltage Vth, electric current little flows into EL element, and does not emit light. Therefore, as shown by a solid line in FIG. 2C brightness properties of the EL element are such that the higher the voltage V to be applied is, the greater the emission brightness L becomes in a light emittable region where the drive voltage is greater than the above-mentioned threshold voltage Vth.

On the other hand, it is known that the above-mentioned organic EL element changes in properties of the device and a forward voltage Vf becomes large when used for a long time. For this reason, as shown in FIG. 2B, a V-I(L) property (property as shown by a dashed line) of the organic EL element changes with actual operating time in the direction as shown by an arrow, therefore the brightness properties are also reduced.

Furthermore, it is also known that the brightness properties of the organic EL element generally change with temperature as shown by a dashed line in FIG. 2C. In other words, in the light emittable region where the drive voltage is greater than the above-mentioned light-emitting threshold voltage, the EL element has the property that the larger the value of the voltage V applied to it is, the greater the emission brightness L is, while the higher the temperature is, the smaller the light-emitting threshold voltage becomes. Therefore, EL element is in a situation where light can be emitted with a smaller applied voltage at a higher the temperature, and has a temperature dependent brightness where it is bright at a high temperature and dark at a low temperature even if the same voltage capable of emitting light is applied.

Furthermore, the above-mentioned EL element has a problem that luminous efficiencies with respect to the drive voltages differ according to the luminescence colors. The luminous efficiencies of EL elements, which may currently be put into practical use, emitting respectively R (red), G (green), and B (blue) lights are in a situation where the luminous efficiency of G is generally higher and the luminous efficiency of B is the lowest at an early stage as shown in FIG. 2D. Further, each of the EL elements emitting R, G, and B lights has a variation over time and temperature dependency as shown in FIGS. 2B and 2C.

As described above, the EL elements change in emission brightness according to ambient temperature as well as variations over time. Thus, the present applicant has proposed a drive apparatus arranged such that, in order to compensate the brightness property, an EL monitoring element may be used to obtain the forward voltage and to control, based on the forward voltage, a supply voltage for causing and driving the EL display element to emit light. An example as mentioned above is disclosed in the following patent document 1.

[Patent Document 1]

Japanese Laid-open Patent No. 2004-252036

Incidentally, the above-mentioned light emitting display panel has a dimmer function which generally controls a display brightness of the whole panel. An example of such a means for achieving such a dimmer function is electric current dimmer control. This electric current dimmer control is for controlling drive current supplied to the EL element which constitutes each pixel. In a particular example, it is possible to employ a drive circuit structure as shown in FIG. 3.

In the structure as shown in FIG. 3, it is arranged that when a desired dimmer value is set, dimmer information of a selected digital datum is supplied to a D/A converter 1 and converted into an analog voltage, then an electric current value of a constant electric current source 2 may be changed with this analog voltage. In other words, the D/A converter 1 and the constant electric current source 2 constitute an electric current value varying means. The electric current from the above-mentioned constant electric current source 2 is arranged to be supplied to an monitoring organic EL element Ex which is stacked and formed at an end, for example, of the display panel as will be illustrated later, during which time the forward voltage Vf is generated in the monitoring EL element Ex and then supplied to a sample hold circuit 3.

The above-mentioned forward voltage held by the above-mentioned sample hold circuit 3 is arranged to be supplied as a control voltage to a DC-DC converter 5 as a drive voltage control unit through a buffer amplifier 4. The above-mentioned DC-DC converter 5 constitutes a booster-type converter which uses a battery, for example, as a primary power source, and an output voltage VH via this converter is used as a power source for driving the light emitting display panel.

Therefore, the output voltage VH obtained by means of the above-mentioned converter 5 is converted into a drive voltage according to the setup of the above-mentioned dimmer value, and into a drive voltage for compensating the emission brightness corresponding to ambient temperature at which light emitting elements (organic EL elements) arranged in the light emitting display panel are operated and to variations over time.

Incidentally, when electric current is always supplied from the constant electric current source 2 to the above-mentioned monitoring EL element Ex, based on the variations over time a difference in the forward voltages arises between the monitoring EL element Ex and the EL display elements arranged in the light emitting display panel, so that suitable brightness compensation may not be carried out. Further, it is also known that luminescence lifetime of the element can be prolonged by periodically applying a reverse voltage (reverse bias voltage) which does not contribute to light emission, without always applying the forward voltage to the organic EL element, or by periodically setting both terminals of the EL element to the same potential (short circuit).

Then, in the structure of the drive circuit as shown in FIG. 3, it is arranged that a field effect transistor Q1 as a switching element is connected between both terminals of the monitoring EL element Ex, and the transistor Q1 is subjected to on/off control by means of a pulse signal from a first timing controller 6. Thus, it is possible to prevent the difference in the forward voltages due to the variations over time from arising between the monitoring EL element Ex and the EL display elements arranged in the light emitting display panel, and to periodically set both the terminals of the monitoring EL element Ex to the same potential, so that the lifetime of the element can be prolonged.

On the other hand, as described above, when the structure is such that the switching transistor Q1 is connected between both the terminals of the monitoring EL element Ex, a need arises to synchronize sampling timing in the above-mentioned sample hold circuit 3 with on/off operation of the transistor Q1. For this reason, in the sample hold circuit 3, a transistor Q2 for sampling is inserted between a buffer amplifier 7 and a voltage hold capacitor C1, and this transistor Q2 is arranged to be subjected to on/off control by means of a pulse signal from a second timing controller 8.

In the structure which obtains the drive voltage for the display panel by means of the sample hold circuit 3 as shown in FIG. 3, FIG. 4 illustrates the sampling timing of an analog voltage (the above-mentioned forward voltage) by means of the transistor Q2 according to a level of the dimmer control with respect to the timing of the on/off operation of the transistor Q1.

In other words, FIG. 4(A) shows a status of the on/off operation of the transistor Q1, and this is a pulse signal supplied from the above-mentioned first timing controller 6. Further, FIG. 4(B) shows sampling timing by means of the transistor Q2 when the level of the dimmer control is high (when a display screen is controlled to be bright), and FIG. 4(C) shows sampling timing by means of the transistor Q2 when the level of the dimmer control is low (when the display screen is controlled to be dark).

As described above, since the parasitic capacitance exists in the EL element Ex, rise properties of the forward voltage Vf as illustrated in FIGS. 4(B) and 4(C) are slow when the transistor Q1 is turned OFF as shown in FIG. 4 (A). In this case, when the level of the dimmer control is high as shown in FIG. 4(B), a value of the electric current supplied from the constant electric current source 2 is large, so that the voltage rises quickly to reach the forward voltage Vf1 at this time. Further, when the level of the dimmer control is low as shown in FIG. 4(C), the value of the electric current supplied from the constant electric current source 2 is small, so that the voltage rises slowly to reach the forward voltage Vf2 at this time.

For this reason, as shown by arrows in FIGS. 4(B) and 4(C), a need arises to change the timing for generating the pulse signal for sampling supplied to the transistor Q2 from the second timing controller 8, according to setup conditions of the dimmer. Therefore, a means for particularly performing the control as mentioned above is needed, which leads to complicated operation, a large-scale circuit structure, and increased product costs.

### SUMMARY OF THE INVENTION

The present invention has been made in view of the above-mentioned technical problems, and particularly aims to provide a drive apparatus and a drive method for a light emitting display panel for carrying out brightness compensation and dimmer control corresponding to variations over time etc. of a light emitting element, without requiring sampling timing adjustment which is caused by using such a sample hold circuit, as described above.

In order to solve the above-mentioned problems, a drive apparatus for a light emitting display panel in accordance with the present invention is provided in which a large number of light emitting elements are arranged as display pixels, each of the above-mentioned light emitting elements is selectively driven and caused to emit light based on an image signal so as to display an image based on the above-mentioned image signal, and the drive apparatus comprises a monitoring element which is supplied with electric current from a constant electric current source so as to obtain a voltage value corresponding to a forward voltage for a light emitting display element arranged in the above-mentioned light emitting display panel; a drive voltage control means for controlling a drive voltage provided for each of the light emitting elements arranged in the above-mentioned light emitting display panel, based on the voltage value corresponding to the above-mentioned forward voltage obtained by the above-mentioned monitoring element; and a reset circuit for resetting the voltage value held by a peak hold circuit for holding the above-mentioned forward voltage obtained by the above-mentioned monitoring element, wherein the voltage value corresponding to the forward voltage for the above-mentioned light emitting display element is obtained by the above-mentioned peak hold circuit.

Further, in order to solve the above-mentioned problems, a drive method for a light emitting display panel in accordance with the present invention is provided in which a large number of light emitting elements are arranged as display pixels, and each of the above-mentioned light emitting elements is selectively driven and caused to emit light based on an image signal so as to display an image based on the above-mentioned image signal, the above-mentioned drive method comprises the steps of obtaining a voltage value corresponding to a forward voltage for a light emitting display element arranged in the above-mentioned light emitting display panel by supplying electric current from a constant electric current source to a monitoring element; performing control operation of controlling a drive voltage provided for each of the light emitting elements arranged in the above-mentioned light emitting display panel, based on the voltage value corresponding to the above-mentioned forward voltage obtained by the above-mentioned monitoring element; acquiring, by means of a peak hold circuit, the forward voltage obtained by the above-mentioned monitoring element as the voltage value corresponding to the forward voltage for the above-mentioned light emitting display element; and performing reset operation of resetting the voltage value held by the above-mentioned peak hold circuit.

### BRIEF DESCRIPTION OF THE DRAWINGS

FIG. 1 is an equivalent circuit diagram of an organic EL element;

FIGS. 2 are static characteristic graphs showing properties of the organic EL element;

FIG. 3 is a circuit block diagram showing an example of a drive apparatus having problems to be solved by the present invention;

FIG. 4 is a timing chart for explaining sample hold operation carried out in the structure as shown in FIG. 3;

FIG. 5 is a circuit block diagram showing a first preferred embodiment of a drive apparatus in accordance with the present invention;

FIG. 6 is a circuit block diagram showing a particular example of a DC-DC converter used in the structure as shown in FIG. 5;

FIG. 7 is a circuit block diagram showing an example of a display panel which is controlled to emit light by using an output voltage by means of the structure as shown in FIG. 5;

FIG. 8 is a block diagram showing an example in which the structure as shown in FIG. 5 is employed as a drive apparatus for a color display panel;

FIG. 9 is a circuit block diagram showing a second preferred embodiment of the drive apparatus in accordance with the present invention; and

FIG. 10 is a circuit block diagram showing a third preferred embodiment of the drive apparatus in accordance with the present invention.

### DESCRIPTION OF THE PREFERRED EMBODIMENTS

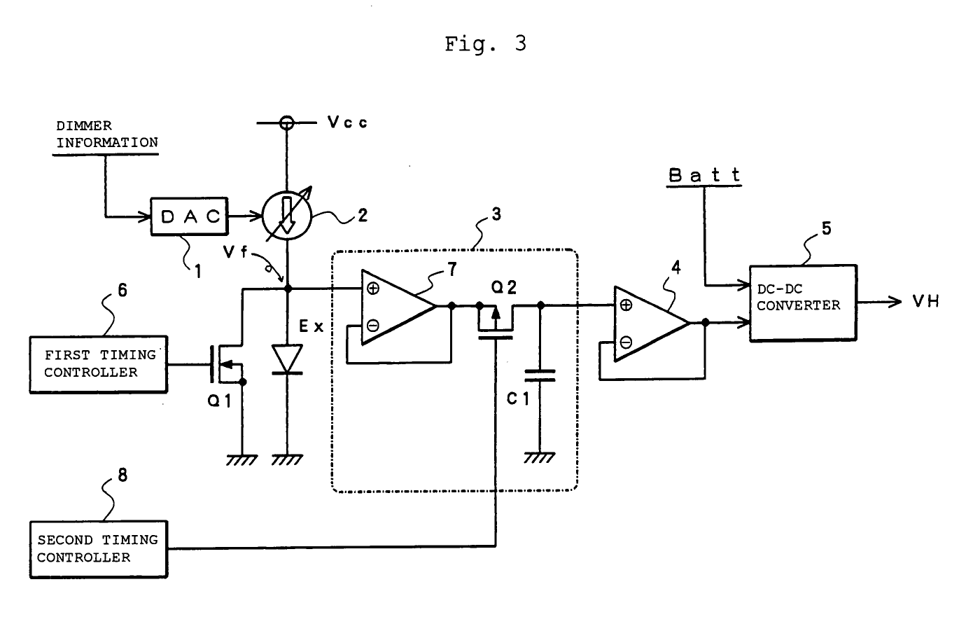

Hereafter, a drive apparatus for a light emitting display panel in accordance with the present invention will be described with reference to preferred embodiments as shown in the drawings. FIG. 5 shows a first preferred embodiment of the light emitting display panel. In FIG. 5, the same reference numerals are used for corresponding parts which achieve the same functions as those described with reference to FIG. 3, and therefore the detailed description of these parts may not be repeated.

The transistor Q1 as a switching element is also connected between both the terminals of the monitoring element Ex in the preferred embodiment as shown in FIG. 5. The transistor Q1 is arranged to be subjected to on/off control by means of the pulse signal from the timing controller 6. Thus, it is possible to prevent the difference in the forward voltages due to the variations over time from arising between the above-mentioned monitoring element Ex and the EL display elements arranged in the light emitting display panel, and to periodically set both the terminals of the monitoring EL element Ex to the same potential, so that the lifetime of the element may be prolonged.

And the forward voltage Vf of the monitoring element Ex in the preferred embodiment as shown in FIG. 5 is arranged to be held by a peak hold circuit 9 which is constituted by the buffer amplifier 7, a peak detection diode D1, and a peak value hold capacitor C1. The output from the above-mentioned peak hold circuit 9 is supplied via the buffer amplifier 4 to the DC-DC converter 5 as a drive voltage control means. Based on the output from the above-mentioned peak hold circuit 9, the converter 5 operates so as to generate a drive voltage VH to be provided for each light emitting element of the display panel.

Therefore, also the drive voltage VH obtained by the above-mentioned converter 5 is arranged to be a drive voltage according to the setup of the above-mentioned dimmer value, and to be a drive voltage for compensating the emission brightness corresponding to ambient temperature at which light emitting elements (organic EL elements) arranged in the light emitting display panel are operated and variations over time.

According to the preferred embodiment as shown in FIG. 5, when the display screen is controlled, for example, to be bright as the dimmer setup is changed, the forward voltage Vf of the monitoring element Ex also increases with increasing amount of the constant electric current from the constant electric current source 2. Therefore, the above-mentioned peak hold circuit 9 holds the increased peak hold value. In this case, even if the above-mentioned transistor Q1 as the switching element is turned on/off, the above-mentioned peak hold circuit 9 operates, despite the turning on/off, so as to hold a peak value of the forward voltage Vf of the monitoring element Ex, and to control the drive voltage VH from the above-mentioned converter 5. Therefore, as described above, when the display screen is controlled to be bright, it is possible for the screen display to immediately reflect the changed status of the dimmer setup.

On the other hand, for example, when the dimmer setup to darken the display screen is carried out, the forward voltage Vf of the monitoring element Ex also decreases with decrease in the amount of the constant electric current from the constant electric current source 2. In this case, a hold value held by the above-mentioned peak hold circuit 9 is gradually reduced by input impedance of the above-mentioned buffer amplifier 4 etc. Then, the peak hold value corresponding to the dimmer setup is held. Also in this case, even if the above-mentioned transistor Q1 as the switching element is turned on/off, the above-mentioned peak hold circuit 9 operates, despite the turning on/off, so as to hold the peak hold value corresponding to the dimmer setup. Although the operation is slow, it is possible for the screen display to reflect the changed status of the dimmer setup.

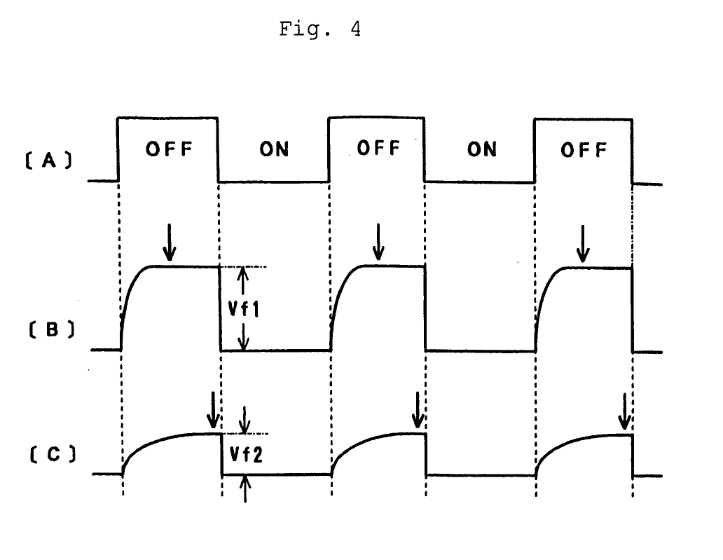

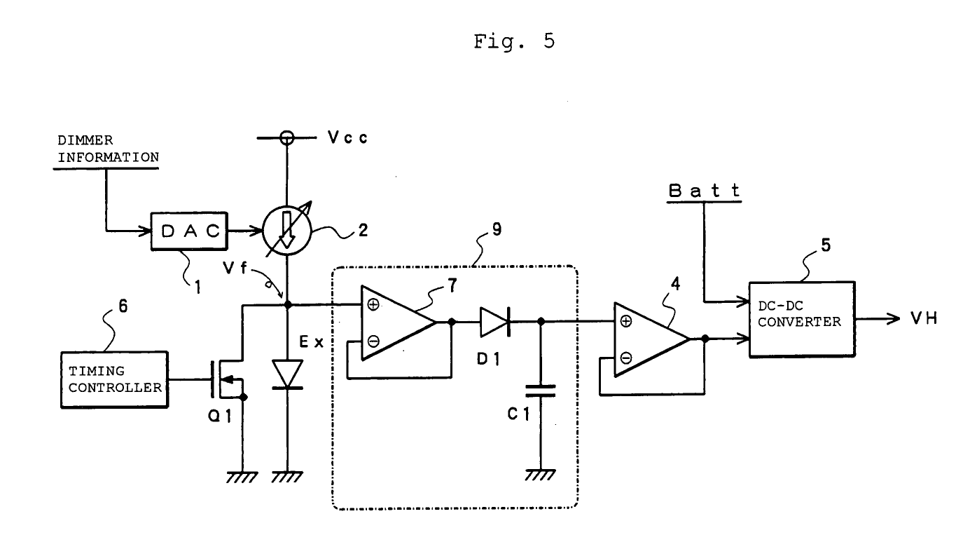

Therefore, unlike the case where the sample hold circuit 3 as described above with reference to FIGS. 3 and 4 is employed, according to the structure in which the above-mentioned peak hold circuit 9 is employed in order to hold the forward voltage Vf of the monitoring element Ex, it is not necessary to aim to adjust pulse output timing of the second timing controller 8 with respect to the first timing controller 6 etc. according to the setup conditions of the dimmer. Therefore, according to the structure in which the peak hold circuit 9 as shown in FIG. 5 is employed, it becomes possible to realize brightness compensation and dimmer control corresponding to variations over time etc. of the light emitting element, without enlarging the circuit structure.

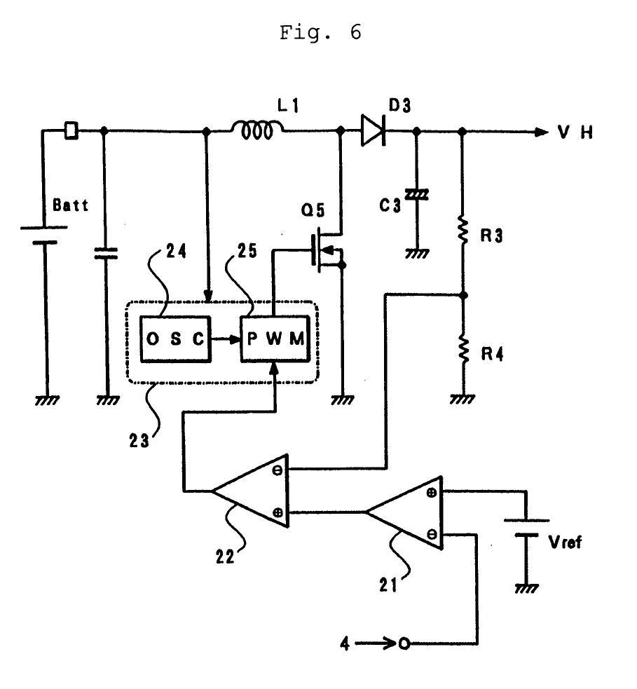

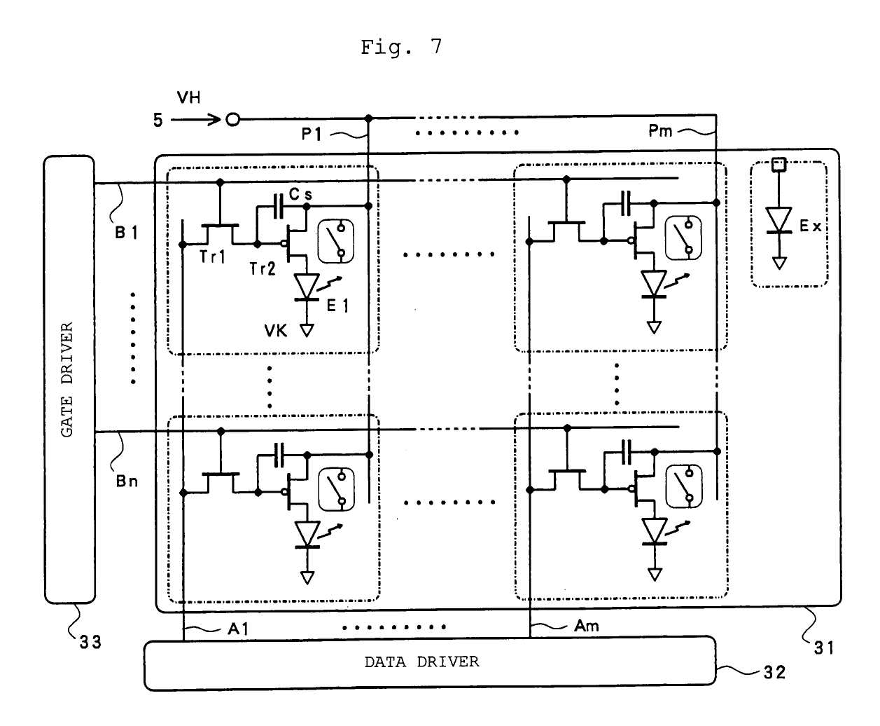

FIG. 6 is for explaining a particular example of the DC-DC converter indicated by reference 5 in FIG. 5. In other words, output (input for controlling the converter) from the buffer amplifier 4 as shown in FIG. 5 is arranged to be supplied to one input terminal (inverting input terminal) in an error amplifier 21 of an operational amplifier. Further, a reference voltage Vref is supplied to the other input terminal (non-inverting input terminal) in the above-mentioned error amplifier 21, therefore a comparison output (error output), comparison between the output from the buffer amplifier 4 and the reference voltage Vref, is generated in the error amplifier 21.

Further, the output from the error amplifier 21 is arranged to be supplied to one input terminal (non-inverting input terminal) in an error amplifier 22 of an operational amplifier. Furthermore, the other input terminal (inversing input terminal) of the error amplifier 22 is arranged to be supplied with divided voltage output by means of resistance elements R3 and R4 which divide the output voltage VH in the DC-DC converter. Therefore, an output voltage value in the error amplifier 22 includes both output information data which are the output from the above-mentioned buffer amplifier 4 and the output VH from the DC-DC converter.

In the structure as shown in FIG. 6, a booster-type DC-DC converter is used, and the output from the above-mentioned error amplifier 22 is arranged to be supplied to a switching-signal generation circuit 23. This switching-signal generation circuit 23 is provided with a reference sawtooth wave (triangular wave) oscillator 24 and a PWM (pulse width modulation) circuit 25. A comparator (not shown) is provided for the above-mentioned PWM circuit 25. This comparator is supplied with the output from the above-mentioned error amplifier 22 and a sawtooth wave (triangular wave) from the reference sawtooth wave oscillator 24, so that a PWM signal is generated from the PWM circuit 25.

The pulse signal generated by way of PWM from the above-mentioned PWM circuit 25 is arranged to be supplied to a gate of a power FET Q5, so as to switch the FET Q5. In other words, power energy from a battery Batt is accumulated in an inductor L1 by switching ON the above-mentioned FET Q5. On the other hand, as the FET Q5 is subjected to OFF operation, the power energy accumulated in the above-mentioned inductor is accumulated in a capacitor C3 via a diode D3.

By repeating the on/off operation of the above-mentioned FET Q5, the boosted (rise in voltage) DC output can be obtained as a terminal voltage of the capacitor C3, so as to be the output voltage VH from the converter. As described above, this output voltage VH is divided by the resistance elements R3 and R4, and fed back to the error amplifier 22, so that the output voltage VH maybe maintained constant. Thus, it is possible to supply the drive voltage VH which can realize the brightness compensation and the dimmer control corresponding to an operating temperature and variations over time in the light emitting elements of the display panel.

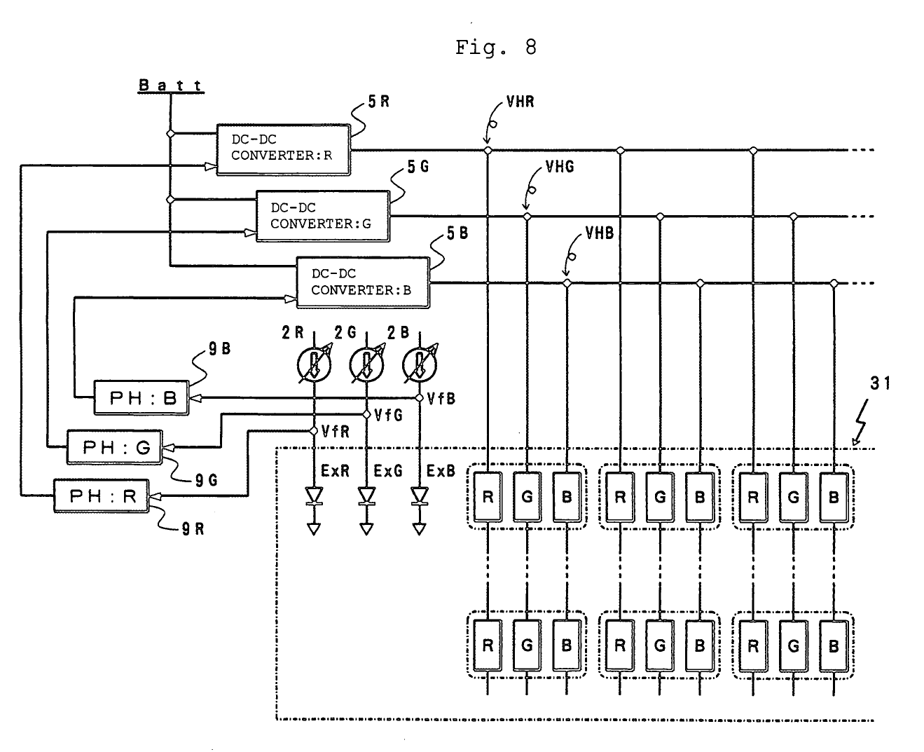

FIG. 7 shows an example of an active-matrix type light emitting display panel which causes and drives each light emitting element to emit light by using the drive voltage VH supplied from the above-mentioned DC-DC converter. In addition, given the limited space in the paper, FIG. 7 shows only a partial structure of four pixels arranged at four corners of a display panel 31, and pixels located among the four pixels are not shown.

As shown in FIG. 7, data lines A1-Am to which data signals that are from a data driver 32 and based on an image signal are supplied are vertically arranged in the display panel 31, and scanning selection lines B1-Bn to which scanning selection signals from a gate driver 33 are supplied are horizontally arranged. Furthermore, power supply lines P1-Pm are vertically arranged in the display panel 31, respectively corresponding to the above-mentioned data lines. These power supply lines are arranged to be provided with the drive voltage VH supplied from the DC-DC converter 5 as shown in FIGS. 5 and 6.

As shown, each of the pixels arranged in the display panel 31 has a pixel construction by way of a conductance control method, for example. In other words, as each element which constructs the pixel of the upper left corner as shown in FIG. 7 is indicated by a reference sign, a gate of a control transistor Tr1 constituted by an n-channel type TFT is connected to the scanning selection line B1, and a source is connected to the data line Al. Further, a drain of the control transistor Tr1 is connected to a gate of an emission driving transistor Tr2 constituted by a p-channel type TFT and also connected with one terminal of a charge storing capacitor Cs.

And a source of the emission driving transistor Tr2 is connected to the other terminal of the above-mentioned capacitor Cs and connected with the power supply line P1. Further, an anode of an organic EL element E1 as a light emitting element is connected to the drain of the emission driving transistor, and a cathode of the EL element El is connected to a common electrode on the cathode side as indicated by a voltage value VK.

In the above-mentioned pixel structure, when an ON-state voltage is supplied to the gate of the control transistor Tr1 from the gate driver 33 via the scanning selection line B1, the control transistor Tr1 causes the electric current corresponding to a data voltage supplied to the source from the data line A1 to flow from the source to the drain. Therefore, while the gate of the control transistor Tr1 is the ON-state voltage, the above-mentioned capacitor Cs is charged and its voltage is supplied to the gate of the emission driving transistor Tr2.

Therefore, the emission driving transistor Tr2 is turned on based on its gate-source voltage, applies the drive voltage VH (supplied from the above-mentioned DC-DC converter 5) to the EL element E1, and causes and drives the EL element to emit light. In other words, the emission driving transistor Tr2 which is constituted by the TFT in this preferred embodiment is arranged such that switching operations (in linear region) may be carried out between two modes, ON and OFF, by the data voltage supplied from t-he data driver.

On the other hand, when the gate of the control transistor Tr1 is an OFF state voltage, the transistor is so-called cut off and the drain of the control transistor Tr1 is in an open state. However, the gate voltage is held by the charge accumulated in the capacitor Cs, and the emission driving transistor Tr2 maintains the state of applying the above-mentioned drive voltage VH to the EL element E1 until the next scan, whereby the light emission of the EL element E1 is also maintained.

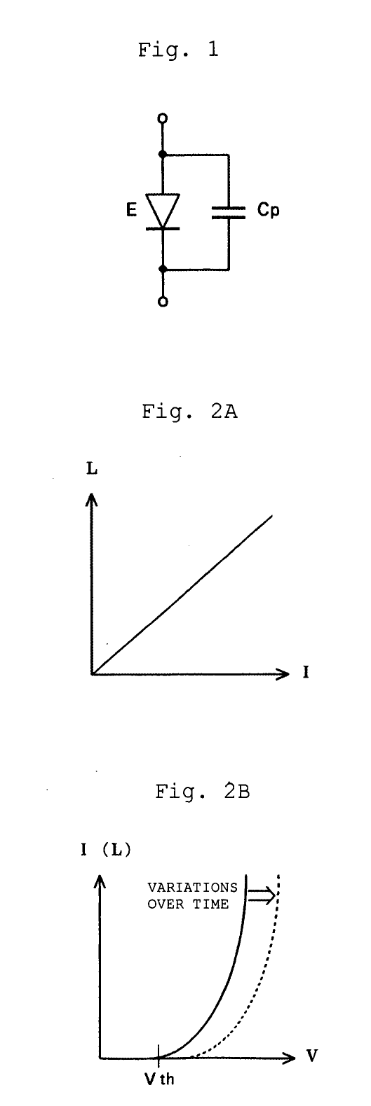

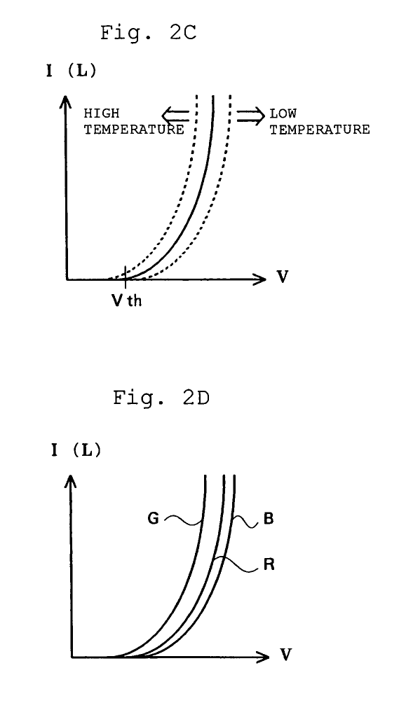

As already described, the drive voltage VH supplied from the above-mentioned DC-DC converter 5 is caused to be the drive voltage according to the setup of the above-mentioned dimmer value, and to be the drive voltage for compensating the emission brightness corresponding to ambient temperature and variations over time of the light emitting elements arranged in the light emitting display panel. Therefore, the EL element E1 which constitutes each pixel is selectively supplied with the above-mentioned drive voltage VH and controlled to emit light along the V-I(L) properties as shown in FIG. 2.

In addition, reference Ex located at an edge of the display panel 31 as shown in FIG. 7 indicates the above-mentioned monitoring element. This monitoring element Ex is simultaneously formed at the time of forming each display element E1 arranged in the display panel. In other words, if both the display element E1 and the monitoring element Ex are organic EL elements, then they have the same variations over time and emission brightness properties dependent on the temperature by forming them as a film on a substrate of the panel 31 simultaneously.

In the preferred embodiments as described above, it is assumed that a light emitting element allows image display by way of a monotone in one luminescence color. However, as described above with reference to FIG. 2D, the organic EL element has a problem that the luminous efficiencies with respect to the drive voltages differ according to the luminescence colors. Further, each of the EL elements emitting R, G, and B lights has the variation over time and temperature dependency as shown in FIGS. 2B and 2C.

Therefore, in the case where EL elements emitting respective colors of R, G, and B are arranged to carry out color display, a problem arises in that color-balance (white balance) is disturbed by ambient temperature and variations over time, which makes it difficult to maintain display quality constant. Especially, as shown in FIG. 7, in a drive apparatus for the active-matrix type display panel where each EL element is driven with a constant voltage by way of the switching operation of the TFT, a problem arises in that the emission brightness changes with variations of the forward voltage Vf for each element as indicated by V-I (L) properties shown in FIG. 2, resulting in severely impaired display quality.

Then, in order to solve the problems as mentioned above, it is desirable to arrange that the monitoring elements for respectively monitoring the forward voltages Vf for causing the EL elements to emit respective R, G, and B lights are provided, and the structure as shown in FIG. 5 is individually provided for each luminescence color. FIG. 8 shows an example of the arrangement.

Color display pixels surrounded by dotted lines in which each group includes sub-pixels as indicated by R, G, and B are arranged in a matrix layout in the display panel 31 as shown in FIG. 8. In other words, each of the sub-pixels indicated by R, G, and B constitutes a respective one of display pixels as shown in FIG. 7, for example. In addition, given the limited space in the paper, FIG. 8 shows only part of the arrangements of the color display pixels.

Further, monitoring elements ExR, ExG, and ExB of the organic EL elements respectively corresponding to colors R, G, and B are arranged at part of the display panel 31, and respectively provided with a constant electric current source 2G for supplying constant electric current to the monitoring element ExG corresponding to G, a constant electric current source 2R for supplying constant electric current to the monitoring element ExR corresponding to R, and a constant electric current source 2B for supplying constant electric current to the monitoring element ExB corresponding to B.

In addition, it is arranged that a forward voltage VfR generated when constant electric current is supplied from the above-mentioned constant electric current source 2R to the monitoring element ExR is supplied to a peak hold circuit 9R, and a forward voltage VfG generated when constant electric current is supplied from the constant electric current source 2G to the monitoring element ExG is supplied to a peak hold circuit 9G. Similarly, it is also arranged that a forward voltage VfB generated when constant electric current is supplied from constant electric current source 2B to the monitoring element ExB is supplied to a peak hold circuit 9B.

Further, it is arranged that the peak voltage values corresponding to the forward voltages VfR, VfG, and VfB respectively held by the above-mentioned peak hold circuits 2R, 2G, and 2B, are respectively supplied as control voltages to DC-DC converters 5R, 5G, and 5B as the drive voltage control means. In addition, it is also arranged that those that are equivalent to the transistor Q1 as the switching element as shown in FIG. 5 are respectively connected corresponding to the respective monitoring elements ExR, ExG, and ExB as shown in FIG. 8, and arranged that as shown in FIG. 5 a value of constant electric current maybe changed by using the dimmer information in each of the constant electric current sources 2R, 2G, and 2B as shown in FIG. 8, but these are not shown.

Thus, according to the above-mentioned structure, a drive voltage VHR is outputted from the converter 5R based on the above-mentioned VfR, and is supplied as a drive voltage to the display pixels as indicated by R. Further, a drive voltage VHG is outputted from the converter SG based on the above-mentioned VfG, and is supplied as a drive voltage to the display pixels as indicated by G, as well as a drive voltage VHB is outputted from the converter 5B based on the above-mentioned VfB and is supplied as a drive voltage to the display pixels as indicated by B.

Therefore, according to the structure as shown in FIG. 8, it is possible to prevent the color balance (white balance) from being disturbed by ambient temperature and variations over time, and to maintain the display quality constant.

In addition, in the preferred embodiment as shown in FIG. 8, although an example is shown where the monitoring elements respectively corresponding to the luminescence colors of R, G, and B are provided, it is also possible to cause one monitoring element to compensate, by using its forward voltage, the color balance of the display pixels for two colors, depending on the properties of display elements for R, G, and B, for example. Therefore, in such a case, as described above, a drive apparatus for light emitting display panel which allows color balance (white balance) compensation can be realized by using at least two types of monitoring elements.

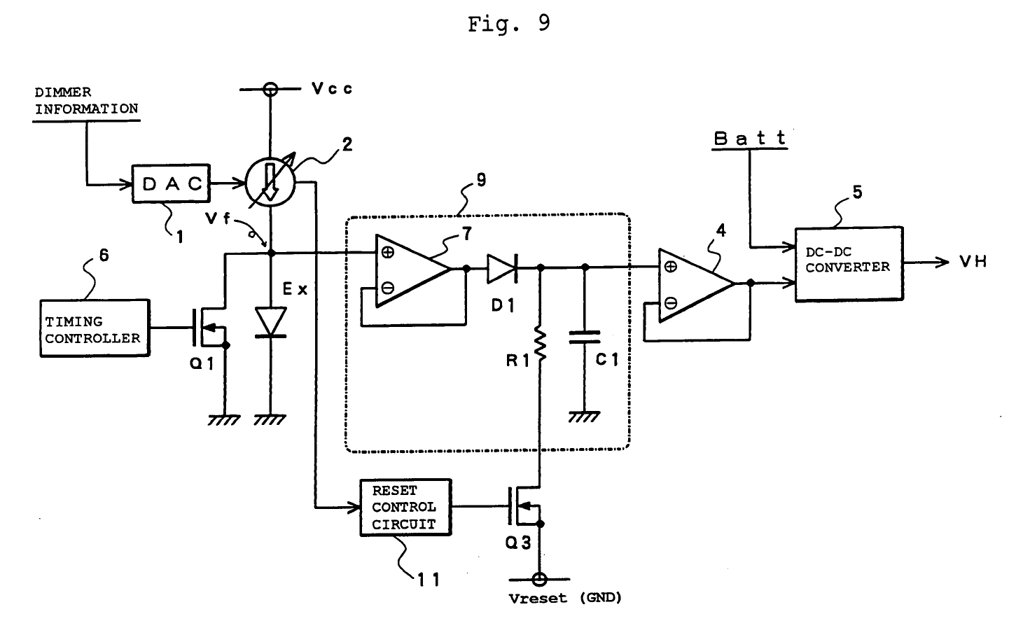

Next, FIG. 9 shows a second preferred embodiment in accordance with the present invention. In FIG. 9, the same reference numerals are used for corresponding parts which achieve the same functions as those described with reference to FIG. 5, and therefore the detailed description of these parts may not be repeated. In the preferred embodiment as shown in FIG. 9, a reset means is further provided for resetting a voltage value held by the above-mentioned peak hold circuit 9.

In other words, a series circuit of a resistance element R1 and a transistor Q3 is connected between both the terminals of the peak hold capacitor C1 in the above-mentioned peak hold circuit 9. Further, it is arranged that a gate terminal of the above-mentioned transistor Q3 is supplied with a control signal from a reset control circuit 11. According to this structure, as the control signal is supplied from the reset control circuit 11, the transistor Q3 is turned on and operates so that charges held by the peak hold capacitor C1 may be discharged (reset) through the resistance element R1.

In the preferred embodiment as shown in FIG. 9, the above-mentioned reset circuit 11 is arranged to operate in response to a variation of a constant electric current value in an electric current value varying means containing the above-mentioned constant electric current source 2. In this case, as one example, a differential circuit for detecting a change in constant electric current value is provided in the above-mentioned reset circuit 11, and the above-mentioned transistor Q3 may be turned ON by output from the differential circuit. According to this structure, each time the dimmer value is re-set up, the transistor Q3 is turned ON and resets the charges held by the capacitor C1, so that the brightness of a screen can quickly be changed corresponding to the dimmer value re-setup.

In addition, when the dimmer value re-setup causes the screen to be brighter, the brightness of the screen is immediately changed by way of the operation of the peak hold circuit 9 without carrying out the above-mentioned reset operation. Therefore, the above-mentioned reset circuit 11 is arranged to operate, only when the dimmer value re-setup is changed so that the screen may be dark, or only when the voltage value corresponding to the forward voltage supplied to the peak hold circuit 9 drops. Thus, the brightness of the screen can be caused to correspond to the setup dimmer value immediately.

As described above, in order to operate the reset circuit 11 only when the screen is altered to be dark by way of re-setup of the dimmer value, differential output may be obtained when the electric current value changes in the negative direction so as to turn on the above-mentioned transistor Q3.

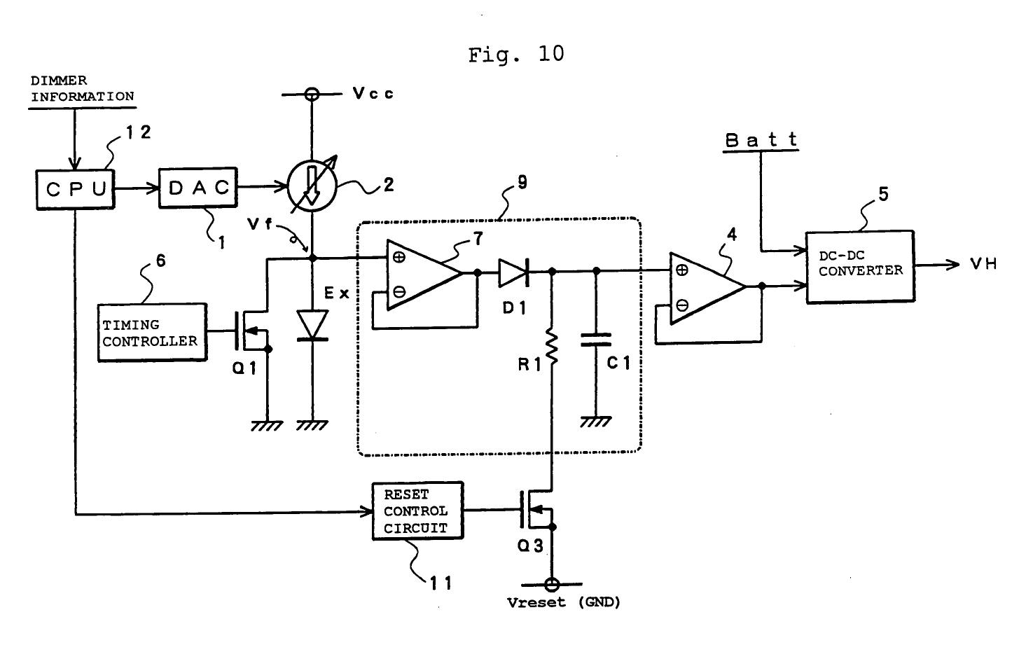

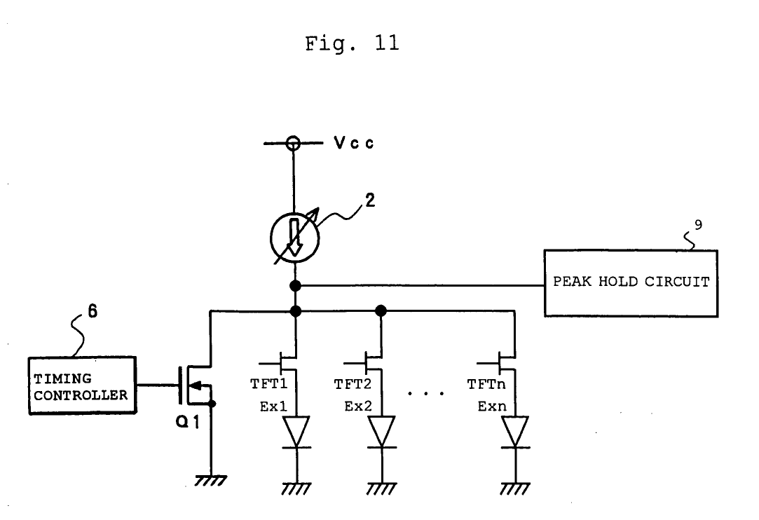

FIG. 10 shows a third preferred embodiment in accordance with the present invention. In FIG. 10, the same reference numerals are used for corresponding parts which achieve the same functions as those described with reference to FIG. 9, and therefore the detailed description of these parts may not be repeated. In the preferred embodiment as shown in FIG. 10, the dimmer value to be set up is arranged to be taken, as dimmer information, into a CPU (central processing unit) 12 which controls the whole drive circuit of the display panel. Further, it is arranged that a digital datum as dimmer information is supplied to a D/A converter 1 through the above-mentioned CPU 12 so as to be converted into an analog voltage.

Further, the above-mentioned CPU 12 is arranged to function to detect a change (re-setup) of the dimmer information in a state of digital data, and to operate the above-mentioned reset control circuit 11 when a change arises in the dimmer information. This structure can also provide operation and effects similar to those of the embodiment as shown in FIG. 9.

Further, in the structure as shown in FIG. 10, according to a comparison between the digital data, the CPU 12 can determine whether or not the dimmer value to be re-set up is to modify the screen to be dark, so that the above-mentioned reset circuit 11 may be arranged to operate only at the time of the re-setup of the dimmer value for modifying the screen to be dark.

In addition, when employing the second preferred embodiment as shown in FIG. 9 or the third preferred embodiment as shown in FIG. 10 in order to drive the color display panel, peak hold circuits, DC-DC converters, etc. having the same structure are provided corresponding to R, G, and B, as shown in FIG. 8. In this case, as already described, it is also possible to compensate the color balance of the display pixels for two colors by using the forward voltage of one monitoring element, depending on the properties of the display elements for R, G, and B. Therefore, in such a case, as described above, a drive apparatus for a light emitting display panel which allows color balance (white balance) compensation can be realized by using at least two types of monitoring elements.

In addition, the drive apparatus for the display panel in the present invention can be applied not only to the drive apparatus for the active-matrix type display panel as shown in FIG. 7, but also to a drive apparatus for a passive matrix type display panel (not shown). Further, in the above-mentioned preferred embodiments, although the examples are illustrated in which the organic EL elements are used as the light emitting display elements arranged in the display panel and the monitoring element, the same effects can be obtained by using other light emitting elements having variations over time and temperature dependency as shown in FIG. 2.

Further, FIG. 11 shows an example of a structure using a plurality of monitoring elements (Ex1, Ex2 . . . Exn) and a plurality of thin-film transistors (TFT1, TFT2 . . . TFTn) as switches controlling supplying/interrupting constant electric current to monitoring elements. In this structure, forward voltage, which reflects voltage drop by ON-resistance of thin-film transistors, can be obtained.

What is claimed is:

1. A drive apparatus for a light emitting display panel in which a plurality of light emitting elements are arranged as display pixels, and each of said light emitting elements is selectively driven and caused to emit light based on an image signal, so as to display an image based on said image signal, said drive apparatus comprising:
a monitoring element which is supplied with electric current from a constant electric current source so as to obtain a voltage value corresponding to a forward voltage for a light emitting display element arranged in said light emitting display panel;
a drive voltage control means for controlling a drive voltage supplied for each of the light emitting elements arranged in said light emitting display panel, based on the voltage value corresponding to said forward voltage obtained by said monitoring element; and
a reset circuit for resetting the voltage value held by a peak hold circuit for holding said forward voltage obtained by said monitoring element,
wherein the voltage value corresponding to the forward voltage for said light emitting display element is obtained by said peak hold circuit.

2. The drive apparatus for the light emitting display panel as claimed in claim 1, wherein an electric current value varying means is provided for variably controlling a constant electric current value supplied to the monitoring element from said constant electric current source, according to dimmer information for setting a display brightness of said display panel; and said reset circuit is arranged to be operated in response to a variation of the constant electric current value in said electric current value varying means.

3. The drive apparatus for the light emittingdisplaypanel as claimed in claim 1, wherein an electric current value varying means is provided for variably controlling a constant electric current value supplied to the monitoring element from said constant electric current source, according to dimmer information for setting a display brightness of said display panel; and said reset circuit is arranged to be operated according to instructions from a CPU which receives said dimmer information.

4. The drive apparatus for the light emitting display panel as claimed in any one of claim 1 to 3, wherein said reset circuit is arranged to be operated only in the case of a drop in the voltage value corresponding to the forward voltage supplied to said peak hold circuit based on a change of said dimmer information.

5. The drive apparatus for the light emitting display panel as claimed in claim 1, wherein the light emitting elements which provide a plurality of different luminescence colors are arranged in the display panel as the light emitting elements which play the role of said display pixels, said monitoring elements corresponding to at least two types of different luminescence colors are provided, and
the peak hold circuits are respectively provided for holding the forward voltages of said respective monitoring elements.

6. The drive apparatus for the light emitting display panel as claimed in anyone of claims 1 to 3, wherein said monitoring element is arranged to be provided with the constant electric current from said constant electric current source intermittently.

7. The drive apparatus for the light emitting display panel as claimed in claim 4, wherein said monitoring element is arranged to be provided with the constant electric current from said constant electric current source intermittently.

8. The drive apparatus for the light emitting display panel as claimed in claim 5, wherein said monitoring element is arranged to be provided with the constant electric current from said constant electric current source intermittently.

9. A drive method for a light emitting display panel in which a plurality of light emitting elements are arranged as display pixels, and each of said light emitting elements is selectively driven and caused to emit light based on an image signal so as to display an image based on said image signal, said drive method comprising the steps of:
obtaining a voltage value corresponding to a forward voltage for a light emitting display element arranged in said light emitting display panel by supplying electric current from a constant electric current source to a monitoring element;
performing control operation of controlling a drive voltage supplied for each of the light emitting elements arranged in said light emitting display panel, based on the voltage value corresponding to said forward voltage obtained by said monitoring element;
acquiring, by means of a peak hold circuit, the forward voltage obtained by said monitoring element as the voltage value corresponding to the forward voltage for said light emitting display element; and
performing reset operation of resetting the voltage value held by said peak hold circuit.

10. The drive method for the light emitting display panel as claimed in claim 9, wherein a constant electric current value is variably controlled which is supplied to the monitoring element from said constant electric current source according to dimmer information for setting a display brightness of said display panel, and said reset operation is performed in response to the variation of said constant electric current value.

11. The drive method for the light emitting display panel as claimed in claim 9, wherein a constant electric current value is variably controlled which is supplied to the monitoring element from said constant electric current source according to dimmer information for setting a display brightness of said display panel, and said reset operation is performed in response to instructions from a CPU which receives said dimmer information.

12. The drive method for the light emitting display panel as claimed in any one of claims 9 to 11, wherein said reset operation is performed only in the case of a drop in the voltage value corresponding to the forward voltage supplied to said peak hold circuit based on a change of said dimmer information.

13. The drive method for the light emitting display panel as claimed in claim 9, wherein the light emitting elements which provide a plurality of different luminescence colors are arranged in the display panel as the light emitting elements which play the role of said display pixels, and said monitoring elements corresponding to at least two types of different luminescence colors are provided, and
operation of respectively causing and driving said light emitting elements to emit light which provide the plurality of different luminescence colors is performed by using any one of drive voltages respectively generated based on the forward voltages for said monitoring elements.

14. The drive method for the light emitting display panel as claimed in any one of claims 9 to 11, wherein operation of intermittently supplying the constant electric current from said constant electric current source to said monitoring element is carried out.

15. The drive method for the light emitting display panel as claimed in claim 12, wherein operation of intermittently supplying the constant electric current from said constant electric current source to said monitoring element is carried out.
